(19) United States
(12) Patent Application Publication
(10) Pub. No.: US 2023/0222905 A1
(43) Pub. Date: Jul. 13, 2023

(54) METHOD, APPARATUS, AND SYSTEM FOR TRAFFIC LIGHT SIGNAL PHASE AND TIMING VERIFICATION USING SENSOR DATA AND PROBE DATA

(71) Applicant: HERE Global B.V., Eindhoven (NL)

(72) Inventors: Jingwei XU, Buffalo Grove, IL (US); Yuxin GUAN, Chicago, IL (US); Bruce BERNHARDT, Wauconda, IL (US); Weimin HUANG, Chicago, IL (US)

(21) Appl. No.: 17/562,532

(22) Filed: Dec. 27, 2021

(51) Int. Cl. G08G 1/082; G08G 1/083; G08G 1/08; G08G 1/01; G06V 20/58; G06V 10/82

(52) U.S. Cl. CPC G08G 1/082; G06V 10/82; G06V 20/584; G08G 1/08; G08G 1/083; G08G 1/0112

(57) ABSTRACT

An approach is provided for traffic Signal Phase and Timing (SPaT) verification using sensor data and probe data. The approach involves, for instance, retrieving image data captured using a sensor of a vehicle traveling within proximity of a traffic light. The approach also involves processing the image data to identify at least one transition of the traffic light between one or more traffic light states. The approach further involves determining a transition time, a cycle time, or a combination thereof between the one or more traffic light states based on the identified at least one transition of the traffic light. The approach further involves performing a comparison of signal phase and timing (SPaT) data of the traffic light with the transition time, the cycle time, or a combination thereof and providing the comparison of the SPaT data as an output.

### BACKGROUND

Mapping and navigation service providers face significant technical challenges with respect to determining and mapping dynamic conditions within road network. One particular challenge is with respect to determining the dynamic states of traffic lights (e.g., green, yellow, red) that control traffic through intersections. Transportation authorities are making the signal phase and timing (SPaT) information for traffic lights more available to service providers. However, the accuracy this provided SPaT information can vary or quickly become out of date because of the complexity and extent of many traffic signaling systems. Knowing accurate signal SPaT information, for instance, enables mapping and navigation service providers to calculate more accurate travel times, estimated times of arrival, optimal navigation routes, and/or the like. Accordingly, mapping and navigation service providers continue to develop technical solutions to ensuring the accuracy SPaT information.

### SOME EXAMPLE EMBODIMENTS

Therefore, there is a need for verifying SPaT information (e.g., received from a transportation authority) using sensor data and probe data from vehicles encountering the traffic lights indicated in the SPaT information to ensure the data is of high-quality and accurate.

According to one embodiment, a method comprises retrieving image data captured using a sensor of a vehicle. The vehicle is determined to be traveling within proximity of a traffic light based on probe data. The method also comprises processing the image data to identify at least one transition of the traffic light between one or more traffic light states. The method further comprises determining a transition time, a cycle time, or a combination thereof between the one or more traffic light states based on the identified at least one transition of the traffic light. The method further comprises performing a comparison of signal phase and timing (SPaT) data of the traffic light with the transition time, the cycle time, or a combination thereof and providing the comparison of the SPaT data as an output.

According to another embodiment, an apparatus comprises at least one processor, and at least one memory including computer program code for one or more computer programs, the at least one memory and the computer program code configured to, with the at least one processor, cause, at least in part, the apparatus to retrieve image data captured using a sensor of a vehicle. The vehicle is determined to be traveling within proximity of a traffic light based on probe data. The apparatus is also caused to process the image data to identify at least one transition of the traffic light between one or more traffic light states. The apparatus is further caused to determine a transition time, a cycle time, or a combination thereof between the one or more traffic light states based on the identified at least one transition of the traffic light. The apparatus is further caused to perform a comparison of signal phase and timing (SPaT) data of the traffic light with the transition time, the cycle time, or a combination thereof and provide the comparison of the SPaT data as an output.

According to another embodiment, a non-transitory computer-readable storage medium carries one or more sequences of one or more instructions which, when executed by one or more processors, cause, at least in part, an apparatus to retrieve image data captured using a sensor of a vehicle. The vehicle is determined to be traveling within proximity of a traffic light based on probe data. The apparatus is also caused to process the image data to identify at least one transition of the traffic light between one or more traffic light states. The apparatus is further caused to determine a transition time, a cycle time, or a combination thereof between the one or more traffic light states based on the identified at least one transition of the traffic light. The apparatus is further caused to perform a comparison of signal phase and timing (SPaT) data of the traffic light with the transition time, the cycle time, or a combination thereof and provide the comparison of the SPaT data as an output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

According to another embodiment, an apparatus comprises means for retrieving image data captured using a sensor of a vehicle. The vehicle is determined to be traveling within proximity of a traffic light based on probe data. The apparatus also comprises means for processing the image data to identify at least one transition of the traffic light between one or more traffic light states. The apparatus further comprises means for determining a transition time, a cycle time, or a combination thereof between the one or more traffic light states based on the identified at least one transition of the traffic light. The apparatus further comprises means for performing a comparison of signal phase and timing (SPaT) data of the traffic light with the transition time, the cycle time, or a combination thereof and providing the comparison of the SPaT data as an output.

In addition, for various example embodiments described herein, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application.

For various example embodiments described herein, the following is also applicable: a method comprising facilitating access to at least one interface configured to allow access to at least one service, the at least one service configured to perform any one method/process or any combination of network or service provider methods (or processes) disclosed in this application.

For various example embodiments described herein, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application.

For various example embodiments described herein, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of traffic light signal phase and timing (SPaT) verification using sensor data and probe data, according to one embodiment;

FIG. 2 is a diagram of components of a mapping platform capable of traffic light signal phase and timing (SPaT) verification using sensor data and probe data, according to one embodiment;

FIG. 3 is a flowchart of a process for traffic light signal phase and timing (SPaT) verification using sensor data and probe data, according to one embodiment;

FIG. 4 is a diagram illustrating an example of a four-way signalized intersection, according to one embodiment;

FIG. 5 is a diagram of illustrating vehicle speed at the intersection of FIG. 4 during different traffic light phases, according to one embodiment;

FIG. 6 is a diagram illustrating vehicle sensor images while approaching a signalized intersection, according to one embodiment;

FIG. 7 is a diagram of a geographic database, according to one embodiment;

FIG. 8 is a diagram of hardware that can be used to implement an embodiment of the processes described herein;

FIG. 9 is a diagram of a chip set that can be used to implement an embodiment of the processes described herein; and

FIG. 10 is a diagram of a terminal that can be used to implement an embodiment of the processes described herein.

### DESCRIPTION OF SOME EMBODIMENTS

Examples of a method, apparatus, and computer program for traffic light signal phase and timing (SPaT) verification using sensor data and probe data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

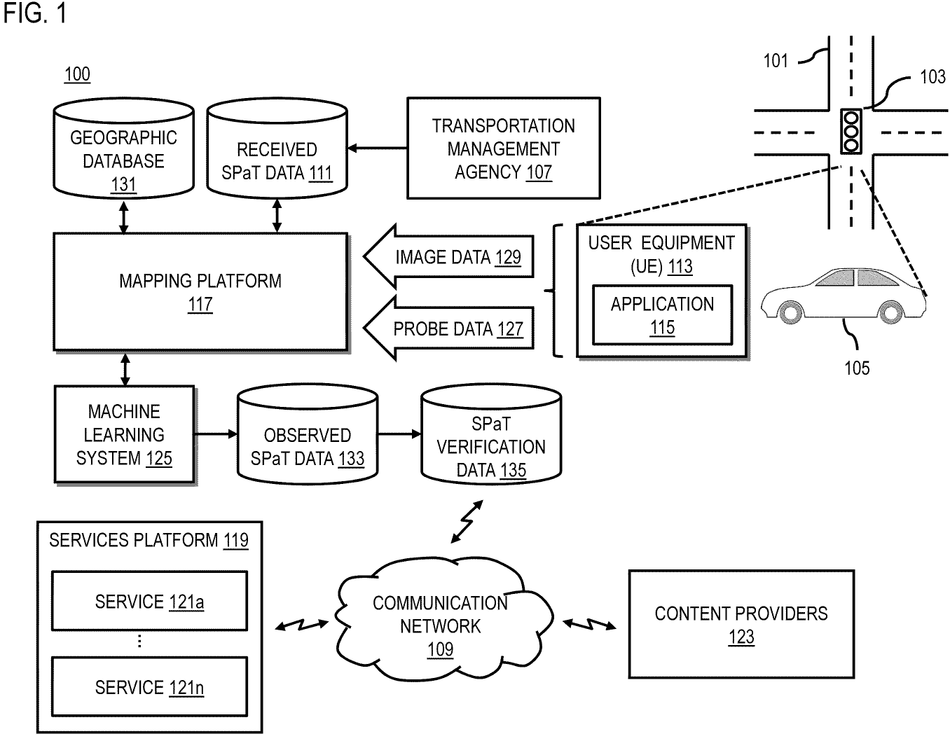

FIG. 1 is a diagram of a system 100 capable of traffic light signal phase and timing (SPaT) verification using sensor data and probe data, according to one embodiment. In the areas of traffic control, autonomous driving, and navigation, an intersection 101 plays a critical role for traffic flow management. Among other things, an intersection 101 includes traffic signal(s) 103 that are installed to provide intersection movement state and flow control strategies to increase vehicle capacity through the intersection 101 and to increase safety of the vehicles 105 driving through the intersection 101.

In general, each traffic light 103 in an intersection 101 has an assigned signal phase and timing (SPaT) control strategy. By way of example, one or more transportation agencies 107 (or any other equivalent service or platform) can provide the SPaT control strategy for traffic lights 103 to components of the system 100 over a communication network 109 as received SPaT data 111. Such information (e.g., received SPaT data 111) about the intersection 101 may be used by autonomous vehicles (e.g., vehicles 105), navigation systems (e.g., of the vehicle 105, user equipment (UE) devices 113 executing applications 115, or equivalent devices), traffic service providers (e.g., a mapping platform 117), other service providers (e.g., a services platform 119 comprising one or more services 121a-121n – also collectively referred to as services 121), content providers 123, and/or traffic management agencies to provide additional opportunities utilizing this information.

In one embodiment, the received SPaT data 111 can include any type of traffic signal timing such as but not limited to: (1) fixed time; (2) actuated; and (3) coordinated Fixed time. For example, fixed time signal control uses preset time intervals that are the same every time the signal cycles, regardless of changes in traffic volumes. For a traffic light 103 comprising green, yellow, and red lights, a cycle comprises transitions from green to yellow, yellow to red, and then back from red to green. It is noted that this cycle is provided by way of illustration and not as a limitation. It is contemplated that a traffic light 103 can use any type signaling indicator (e.g., different color system) or include more or fewer lights (e.g., including lights for different types of turns or maneuvers – e.g., U-turns, restricted lanes, etc.). With respect to a green-yellow-red traffic light 103, the fixed time signaling strategy, for instance, can give the most green time to the heaviest traffic movement based on historical information. Some fixed time systems use different preset time intervals for morning rush hour, evening rush hour, and other busy times. In the example of an actuated signaling system, an actuated signal controller is able to change the amount of green time for each cycle, based on information from loop detectors or other equivalent road sensors that detect the presence of vehicles 105 at an intersection 101. Actuated signals are best where traffic volumes fluctuate considerably during the day or when interruptions to major-street traffic flow must be minimized. In the example of a coordinated signaling system, in addition to timing an individual traffic signals, some signals are timed as a coordinated network. The goal of signal coordination is to help traffic flow through a series of traffic lights 103 at a predetermined speed to minimize or avoid stops. In other words, the traffic light 103 at an intersection 101 can be timed to turn green just as a vehicle 105 arrives. It is noted that this is not always possible because of the need to provide smooth flow in two or more directions. In one embodiment, traffic engineers can use computer programs to determine the best compromise between all the competing directions of traffic in a coordinated signaling system.

The Society of Automotive Engineers (SAE) J2735 standard for Dedicated Short-Range Communications (DSRC) Message Set Dictionary defines a SPaT format that may be used to describe the current state of a traffic signal system for an intersection 101 and the phases corresponding to the specific lanes in the intersection. Thus, in one embodiment, the SPaT information (e.g., received SPaT data 111) may be delivered to the mapping platform 117, vehicle 105, or navigation system (e.g., UE 113) through a DSRC or cellular network (e.g., part of the communication network 109) as the vehicle 105 is approaching to an intersection 101 or is within a certain distance threshold of the intersection 101.

The SAE J2735 standard also defines a MAP data format used to describe the static physical geometry layout of one or more intersections and to convey other types of geographic road information. The MAP message may be used with SPaT information to describe an intersection 101 and the current control state of the intersection 101 in one or more DSRC messages. Additionally, the intersection MAP data may be pre-cached and stored in a vehicle 105 and/or UE 1113 or as part of a navigation system, or the MAP data may be sent to the participating vehicle 105 (e.g., by the transportation management agency 107 and/or the mapping platform 117) as the vehicle 105 approaches the intersection 101 in real-time.

SPaT and MAP data could then be used in real time to support autonomous driving applications crossing signalized intersections 101. In SAE’s autonomy level definitions, there are six levels of driving automation from 0 to 5 shown as below.
Level 0: Automated system issues warnings and may momentarily intervene but has no sustained vehicle control.
Level 1 (“hands on”): The driver and the automated system share control of the vehicle. Examples are Adaptive Cruise Control (ACC), where the driver controls steering and the automated system controls speed; and Parking Assistance, where steering is automated while speed is manual. The driver must be ready to retake full control at any time. Lane Keeping Assistance (LKA) Type II is a further example of level 1 self-driving.
Level 2 (“hands off”): The automated system takes full control of the vehicle (accelerating, braking, and steering). The driver must monitor the driving and be prepared to intervene immediately at any time if the automated system fails to respond properly. The shorthand “hands off” is not meant to be taken literally. In fact, contact between hand and wheel is often mandatory during SAE 2 driving, to confirm that the driver is ready to intervene.
Level 3 (“eyes off”): The driver can safely turn their attention away from the driving tasks, e.g., the driver can text or watch a movie. The vehicle will handle situations that call for an immediate response, like emergency braking. The driver must still be prepared to intervene within some limited time, specified by the manufacturer, when called upon by the vehicle to do so. The 2018 Audi A8 Luxury Sedan was the first commercial car to claim to be capable of level 3 self-driving. The car has a so-called Traffic Jam Pilot. When activated by the human driver, the car takes full control of all aspects of driving in slow-moving traffic at up to 60 kilometers per hour. The function works only on highways with a physical barrier separating one stream of traffic from oncoming traffic.
Level 4 (“mind off”): As level 3, but no driver attention is ever required for safety, i.e., the driver may safely go to sleep or leave the driver’s seat. Self-driving is supported only in limited spatial areas (geofenced) or under special circumstances, like traffic jams. Outside of these areas or circumstances, the vehicle must be able to safely abort the trip, i.e., park the car, if the driver does not retake control.
Level 5 (“steering wheel optional”): No human intervention is required. An example would be a robotic taxi.

As described above, a level 4 vehicle would be driverless in most scenarios and level 5 vehicle is fully non-human involved vehicles. It is contemplated that the various embodiments described herein are applicable to any of the levels described above.

In one embodiment, a 5G network (or any other equivalent high-speed and low-latency wireless network) plays as the important foundation for autonomous driving. It is expected in the future, autonomous vehicles 105 will be everywhere on the road and even safer than current human drivers given their advanced environment sensing capabilities by the development of machine learning models (e.g., as part of a machine learning system 125 operating in the vehicle 105/UE 113 or remotely of a cloud component such as the mapping platform 117) over different kinds of sensor technologies (e.g., camera, radar, Lidar, etc.), vehicle to vehicle (v2v) communications, and vehicle to infrastructure (v2x) communications. These v2v and v2x can be supported by any communications network 109 with low-latency, high capacity, high bandwidth throughput, and high coverage such as but not limited to 5G. All these scenarios generally use a huge amount of data processing and communications to the backend server (e.g., mapping platform 117, services platform 119, and/or the like) and from the backend server to the vehicle 105 and/or adjacent vehicles.

With the recent development v2v and v2x technology, government agencies have started digitizing the intersection traffic light SPaT data. Thus, advanced SPaT data loggers are or will become be available to support autonomous driving and related applications. It enables the customers use such data to optimize transportation related applications. However, because such SPaT information is being used for safety-critical applications such as autonomous driving and/or other transportation related functions, service providers face significant technical challenges with respect to verifying whether the received SPaT data 111 received from a government agency or other authority (e.g., the transportation management agency 107).

The ability to identify the SPaT data quality helps to improve the accuracy of estimated time of arrival (ETA) calculations and other transportation related functions and applications. Traditionally, determining the quality of the received SPaT data 111 depends on resource intensive manual efforts. For example, identifying malfunctioning traffic control signals typically involves a driver suffering through the problem, travelling to their destination, then, if time permits, calling into a police authority to indicate a problem exists.

To address the technical challenges described above, the system 100 of FIG. 1 introduces a capability to verify the SPaT data quality automatically and quickly using probe data 127 and sensor data (e.g., image data 129) captured from vehicles 105 traveling through a signalized intersection 101. It is assumed that signal phase and time (SPaT) information of traffic lights from government agencies (e.g., Department of Transportation (DOT) or DOT authorized third party partners) are available for public use (e.g., as received SPaT data 111). In one embodiment, the received SPaT data 111 is ingested into the mapping platform 117 (or any other backend platform operated by a mapping and/or navigation service provider) through the communication network 109 (e.g., through internet, wireless communication, batch processing from FTP server, and/or equivalent).

In one embodiment, the received SPaT data 111 specifies each traffic light green, yellow, and red cycle information as, for instance, each phase transition time and cycle duration time. As used herein, the term “phase transition time” or “transition time” refers to the duration that a traffic light 103 is in a particular traffic light state (e.g., green state, yellow state, and red state). The term “cycle duration time” or “cycle time” refers to the time the traffic light 103 takes to go through all states (e.g., the time from green to yellow to red and back to green). To verify each signal transition time and cycle time, the system 100 can use sensor data (e.g., image data 129) and/or probe data 127 alone or in combination.

More specifically, in one embodiment, the system 100 (e.g., via the mapping platform 117) retrieves real time probe data 127 (e.g., one or more vehicles 105) at intersection 101 and map matches the probe data 127 (e.g., on a lane level) against map data of a geographic database 131, by checking the probe data speed, timestamp, geolocation data, and/or brake signal data, the received SPaT data 111 can be verified. In one embodiment, the probe data 127 can be used to determine that a vehicle 105 is with proximity of a traffic light based on the locations indicated in the probe data 127 and/or the vehicle speed patterns of the probe data 127 matching a pattern associated with approaching, stopping, and/or driving away from a signalized intersection 101.

In addition or alternatively, the system 100 (e.g., via the mapping platform 117) can retrieve a series vehicle sensor image data recording (e.g., image data 129) from a vehicle 105 (e.g., via camera, Lidar, radar, or equivalent sensor). In one embodiment, the retrieval can be based on corresponding probe data 127 of the vehicle indicating that the vehicle with proximity of a traffic light 103 or has a driving behavior associated being at a signalized intersection 101. The mapping platform 117 can then use deep machine learning techniques (e.g., via a machine learning system 125) to identify traffic light transition time and cycle time (e.g., observed SPaT data 133) from the image data 129. The observed SPaT data 133 can then be compared to the received SPaT data 111 for verification. The verification can be indicated in SPaT verification data 135 which can include SPaT information on one or more traffic lights 103 and whether the received SPaT data 111 matches the observed SPaT data 133 within threshold criteria.

In yet another embodiment, the vehicle 105 and/or UE 113 can detect the traffic light states of a traffic light 103 as vehicle sensor events. In other words, instead of transmitting the probe data 127 and/or image data 129 (or other equivalent sensor data) to the mapping platform 117 for processing, the edge device (e.g., the vehicle 105 and/or UE 113 perform the detection of traffic light states and transmit the states as vehicle sensor events). For example, the reported vehicle sensor event can use vehicle sensor data (e.g., image data 129 and/or probe data 127 as described above) to identify traffic light events (e.g., events indicating traffic light transitions such as green-to-yellow, yellow-to-red, red-to-green trigger events) and report the events with associated timestamps. The mapping platform 117 or other component can then determine observed SPaT data 133 from the reported events and timestamps for verification of the received SPaT data 111.

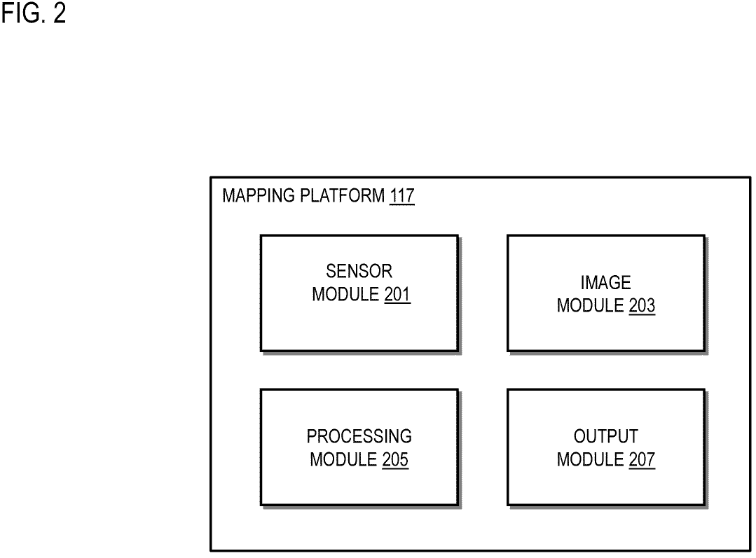

FIG. 2 is a diagram of components of a mapping platform capable of traffic light signal phase and timing (SPaT) verification using sensor data and probe data, according to one embodiment. In one embodiment, as shown in FIG. 2, the mapping platform 117 of the system 100 includes one or more components for SPaT verification according to the various embodiments described herein. It is contemplated that the functions of the components of the mapping platform 117 may be combined or performed by other components of equivalent functionality. As shown, in one embodiment, the mapping platform 117 includes an sensor module 201, an image module 203, and a processing module 205. The above presented modules and components of the mapping platform 117 can be implemented in hardware, firmware, software, or a combination thereof. Though depicted as a separate entity in FIG. 1, it is contemplated that the mapping platform 117 may be implemented as a module of any of the components of the system 100 (e.g., a component of the services platform 119, services 121, content providers 123, vehicles 105, UEs 113, applications 115, and/or the like). In another embodiment, one or more of the modules 201-205 may be implemented as a cloud-based service, local service, native application, or combination thereof. The functions of the mapping platform 117 and modules 201-205 are discussed with respect to the figures below.

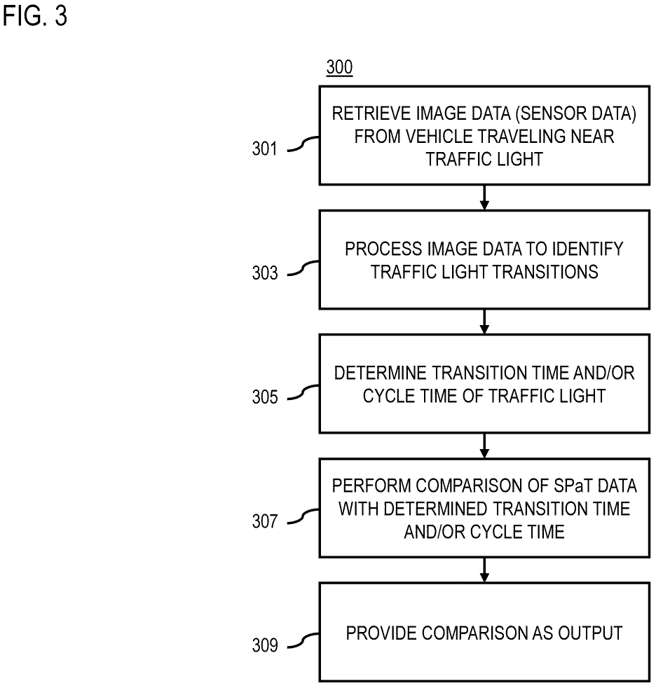

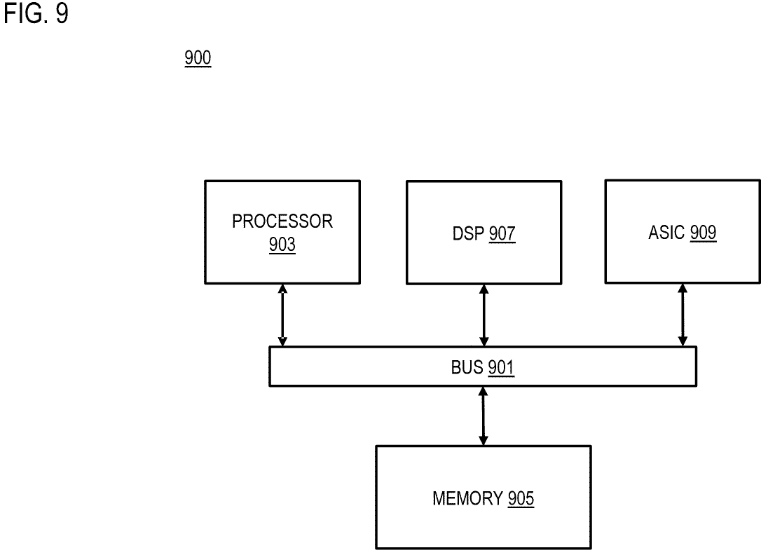

FIG. 3 is a flowchart of a process for traffic light signal phase and timing (SPaT) verification using sensor data and probe data, according to one embodiment. In various embodiments, the mapping platform 117 and/or any of the modules 201-205 may perform one or more portions of the process 300 and may be implemented in, for instance, a chip set including a processor and a memory as shown in FIG. 9. As such, the mapping platform 117 and/or any of the modules 201-205 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In various embodiments of the process 300, the geographic database 131 of the mapping platform 117 is capable of supporting the MAP and SPaT data of the Traffic Light Service Definition. The formats for both MAP and SPaT data are by the Society of Automotive Engineers (SAE) J2735 specification, and the various embodiments described herein are discussed with respect to these formats. However, it is noted that the SAE data formats are provided by way of illustration and not as limitations. The reported SPaT data 111 and corresponding intersection geometry/map data (e.g., the MAP data) can be in any equivalent format for used in the various embodiments described herein. In other words, the two products specified in SAE format are (1) the received SPaT data 111 (also referred to as SPaT information) that provides, for instance, a timely notification of the current state and, if available, the future states over a defined period of the controlling traffic lights 103 (also referred to as traffic signals); and (2) MAP data that describes the geometry of the intersection 101 or other environment in which the traffic light 103 is installed. The MAP data and SPaT data can be categorized by tiles (e.g., corresponding to map tiles of the geographic database 131).

In one embodiment, the MAP data format can be defined in multiple layers such as but not limited to the following:
Layer 1: Stop line - geometry. Lane specific position of stopping line for each traffic available lane in an intersection.
Layer 2: Detailed approach geometry for each lane in an intersection. It is expected that this layer will be as precise and specific as possible given the map service provider’s mapping and probe processing technology.
Layer 3 - Simplified intersection description. This layer would be created by processing the detailed geometry layer in a manner that will provide the most efficient (e.g., smallest number of bytes) description while meeting the map provider’s quality criteria. It is expected that this layer would be indexed to the intersection ID.
Layer 4 - Metadata associated with the traffic light service that would include additional data to help optimize the efficiency of layer 3. For example, this layer may include data such as the distance to nearby intersections or sight line visibility to the intersection around a curve to help define the optimal solution.

It is contemplated that the process 300 can be performed on a server (e.g., via the mapping platform 117) and/or on a client device (e.g., vehicle 105, UE 113, or equivalent) using the application 115. In addition, process 300 can be performed as a batch process or in real-time as probe data 127 and/or image data 129 (or other equivalent sensor data) are collected.

In one embodiment, the process 300 assumes that the retrieved SPaT data 111 that is to be verified is available to the mapping platform 117. If not, the process 300 can begin after the mapping platform 117 retrieves MAP data and SPaT data for an identified signalized intersection. As described above, the retrieved SPaT data 111 represents the traffic light signal phase and timing information as reported from the traffic management agency 107 or other authority (e.g., DOT, third party DOT information provider, etc.). The received that can be stored for later verification or can be retrieved on demand to initiate the SPaT verification process. Table 1 below illustrates an example of Traffic light SPaT JSON information that is received by the mapping platform 117.

TABLE 1

```
{
  “containerCreationTimeStamp”: “2016-07-25T10:09:42.269”,
  “name” : “Swarco”,
  “intersections”: [
    {
      “name” : “intersectionName”,
      “id” : {
        “intersectionId” : “360”,
        “regionId” : “1”
      },
      “timeStamp”: “2016-07-25T10:09:42.269”,
      “states”: [
        {
          “signalGroup”: 4,
          “currentEventState” : 3,
          “stateTimeSpeed” : [ {
              “eventState”: 5,
              “timing”: {
                “likelyTime”: 60,
                “confidence”: 11
              }
            },
            {
              “eventState”: 3,
              “timing”: {
                “likelyTime”: 100,
                “confidence”: 7
              }
            }
          ]
        },
        {
          “signalGroup”: 5,
          “currentEventState” : 3,
          “stateTimeSpeed” : [ {
              “eventState”: 5,
              “timing”: {
                “likelyTime”: 60,
                “confidence”: 11
              }
            },
            {
              “eventState”: 3,
              “timing”: {
                “likelyTime”: 100,
                “confidence”: 7
              }
            }
          ]
        }
      ]
    }
  ]
}
```

In step 301, the sensor module 201 retrieves image data 129 captured using a sensor of a vehicle 105. In one embodiment, the vehicle 105 is determined to be traveling within proximity of a traffic light 103 based on probe data. Accordingly, the image data 129 is likely to depict the traffic light 103 and its current state (e.g., green, yellow, or red). The sensor used to capture the image data 129 includes but is not limited to a camera, radar sensor, lidar sensor, and/or equivalent. A camera, for instance, can produce a visible image. The radar sensor can produce an image based on radar backscatter of radar frequencies (e.g., typically 300 MHz to 30 GHz), and the lidar sensor can produce an image based on reflected laser light. It is contemplated that the images can be two-dimensional or three-dimensional images. In one embodiment, the image data 129 is a sequence of images respectively associated with a capture time, a capture geolocation, or a combination thereof. In other words, each image in the image data 129 has metadata indicating where and when the images are captured. The images can be captured as a part of a video with each image being one frame of the video. It is contemplated that the images can be captured at any sampling frequency with higher frequencies enabling more precise timing of traffic light transition events. In one embodiment, the image data 129 is real-time image data to support real-time verification of SPaT data or can be previously captured data to support verification of historical SPaT data.

In one embodiment, the sensor module 201 can use probe data 127 collected from the vehicles 105 providing the image data 129 to more precisely localize the image data 129 or to determine what portion of the image data 129 to retrieve from the vehicles 105 for processing. For example, the probe data 127 can process the probe data 127 to determine a driving behavior associated with approaching, stopping, and/or accelerating from a traffic light 103. Then image data 129 from during this period of traffic light related driving behavior can be retrieved. In addition, the probe data 127 can also provide a means to further verify the received SPaT data 111 alone or in combination with the image data 129.

In one embodiment, the sensor module 201 processes probe data 127 collected from vehicle(s) 105 (e.g., that shared the image data 129 or is traversing a signalized intersection 101 of interest) to determine a deceleration state, an acceleration state, or a combination thereof. The deceleration and/or acceleration states can then be used to determine or verify at least one transition of the traffic light between the one or more traffic light states.

First, the sensor module 201 retrieves real-time probe data 127 (e.g., trajectory or path data) driving through a signalized intersection 101 of interest. The probe data 127, for instance, is a collection of probes comprising a probe identifier (e.g., to uniquely identify probes from a single vehicle 105 or UE 113), geolocation (e.g., latitude and longitude determined by a location sensor such as, but not limited to, a satellite-based location receiver, or equivalent), a timestamp, and optionally additional parameters such as, but not limited to, a speed, a brake signal to indicate a status of brake actuation, and/or the like

The sensor module 201 that map matches the probe data 127 on a lane level. Map matching, for instances, to translating raw geolocation coordinates (e.g., latitude, longitude) to a position on a road link segment stored in the geographic database 131. It is contemplated that the sensor module 201 can use any map matching method known in the art. The map matching step also enables the sensor module 201 identify the specific traffic light 103 encountered in the probe data 127 because the retrieved SPaT data 111 is generally provided on a lane level as described in the MAP data.

In one embodiment, the sensor module 201 can use the probe data 127 to detect the vehicle speed from free flow to zero before the intersection and check the vehicle deceleration signal to identify the green to yellow to red cycle transitions time. The sensor module 201 can also use the probe data 127 to detect the vehicle speed from full stop before an intersection to speed up cross the intersection and check the vehicle acceleration signal to identify the red to green transitions time.

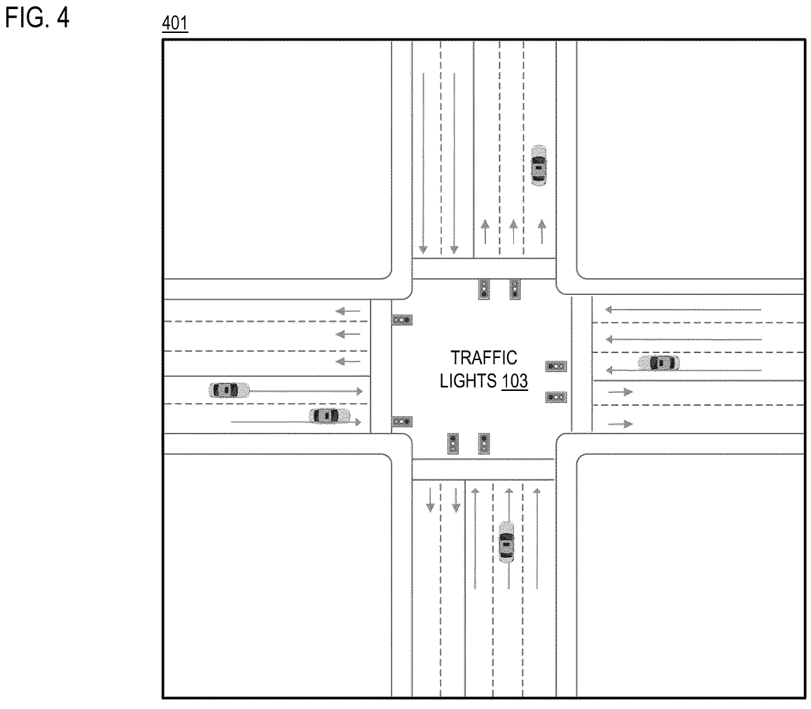

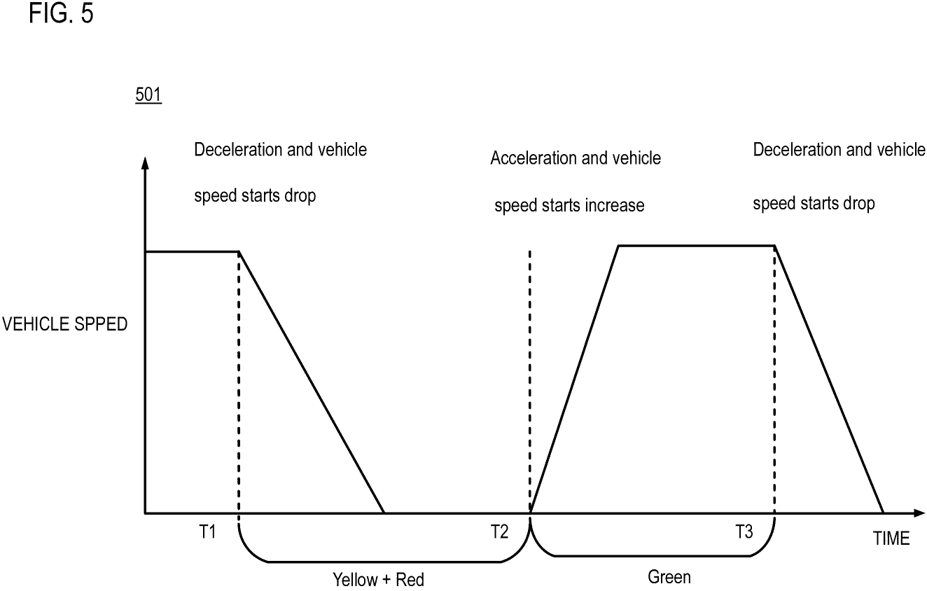

FIG. 4 is a diagram illustrating an example of a four-way signalized intersection 401, and FIG. 5 is a diagram of illustrating vehicle speed at the intersection 401 of FIG. 4 during different traffic light phases, according to one embodiment. More specifically, FIGS. 4 and 5 show different vehicles speed changes (e.g., determined from probe data 127) at a four-way intersection 401 during different traffic light phases. For example, FIG. 5 illustrates a graph 501 of vehicle speed (y-axis) over time (x-axis), according to one embodiment. At time T1, the vehicle 105 decelerates and vehicle speed starts to drop and come to a stop. At time T2, the vehicle 105 accelerates and vehicle speed starts to increase until time T3 when the vehicle 105 decelerates again. Based on this vehicle speed pattern or driving behavior, the sensor module 201 can determine that the yellow light and/or red light states of the traffic light occur between T1 and T2 (e.g., transition time = T2-T1), and the green state occurs from T2 to T3 (e.g., transition time = T3-T2). As noted, these transition times can be compared against the received SPaT data 111 for verification or to select the appropriate image data 129 for verification. For other type intersections other than the 4-way intersection 401 illustrated in FIG. 4, the same approach can be applied as well.

In other words, the sensor module 201 retrieves probe data 127 collected concurrently with the image data 129 using one or more location sensors of the vehicle 105. The sensor module 201 processes the probe data 127 to determine one or more vehicle speed changes through an intersection 101 associated with the traffic signal 103. The sensor module 201 then determines at least one probe-based transition of the traffic light state based on the one or more vehicle speed changes. In one embodiment, the comparison of the SPaT data is further based on the at least one probe-based transition of the traffic light state.

In step 303, the image module 203 processes the image data 129 to identify at least one transition of the traffic light 103 between one or more traffic light states. By way of example, the one or more traffic light states include but are not limited to a green-light state, a yellow-light state, a red-light state, or a combination thereof. Accordingly, the at least one transition of the traffic light state is a green-to-yellow event, a yellow-to-red event, a red-to-green event, or a combination thereof. Then, the processing of the image data comprises determining the transition time, a transition geolocation, or a combination thereof respectively for the green-to-yellow event, the yellow-to-red event, and the red-to-green event; and wherein the cycle time is determined based on the respective transition times, the respective transition geolocations, or a combination thereof.

In one embodiment, the image data 129 is processed using machine learning (e.g., via a machine learning system 125 with a trained machine learning model or algorithm) to identify the at least one transition. One technique that has shown significant ability to detect objects such as traffic lights in images is the use of convolutional neural networks (CNN). Neural networks have shown unprecedented ability to recognize objects in images, understand the semantic meaning of images, and segment images according to these semantic categories. An example of a CNN-based feature detector includes, but is not limited to, the You Only Look Once (YOLO) Real Time Object Detection Algorithm or equivalent. The image data 129, for instance, include multiple images of traffic light 103 taken at different times to identify observed SPaT data 133. The CNN algorithm is able to train itself on a large database of traffic light images in various traffic light states and under different contexts (e.g., different intersections, weather conditions, lighting conditions, traffic light types, etc.). In one embodiment, the image module 203 can input the image data 129 into the trained machine learning module to detect traffic lights and classify corresponding traffic light states. For example, the output of the machine learning system 125 is the observed SPaT data 133 comprising, for instance, a bounding box around each instance of the traffic light 103 in an image and a classification of the traffic light state (e.g., green, yellow, red) of the detected traffic light 103.

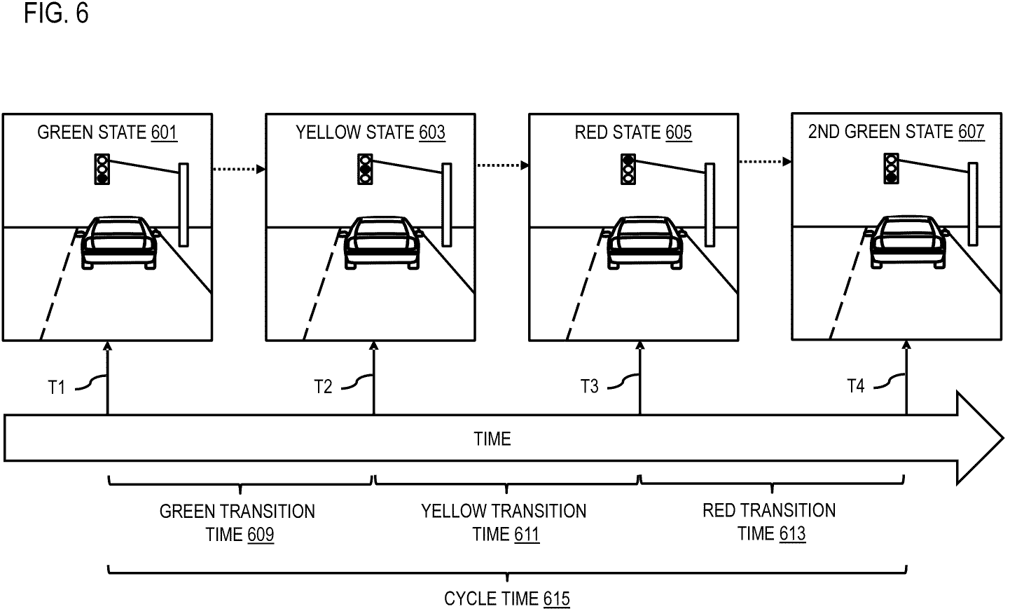

In step 305, after the machine learning process of embodiments above, the processing module 205 determines a transition time, a cycle time, or a combination thereof between the one or more traffic light states based on the identified at least one transition of the traffic light. For example, the observed SPaT data 133 comprises the identified traffic light 103 and traffic light state in each image. Because each image is associated with a corresponding timestamp, the processing module 205 can arrange the observed SPaT data 133 in chronological order for an individual traffic light 103. In one embodiment, the traffic light state transition and cycle times can then be calculated as illustrated with respect to FIG. 6 below.

FIG. 6 is a diagram illustrating vehicle sensor images while approaching a signalized intersection, according to one embodiment. In the example of FIG. 6 a series of images were captured of a traffic light 103 going through a complete cycle from green to yellow to red and then back to green. For example, the image module 203 retrieves real time vehicle sensor image data 129, using deep leaning techniques to identify the images in which the depicted traffic light 103 switches from between different traffic light states (e.g., green to yellow, yellow to red, red to green) to calculate transition and cycle times.

The images were processed using the machine learning system 125 as described above to determine the traffic light 103 and the traffic light state in each image in the series. The processing module 205 can the search for the following: (1) the green state image 601 that first changes from red to green and mark the timestamp associated with the image as the start of the green light state/phase or end of the red light state as time T1; (2) the yellow state image 603 that first changes from green to yellow and mark the timestamp associated with the image as the start of the yellow state or end of the green light state as time T2; (3) search for the red state image 605 that first changes from yellow to red and mark the timestamp associated with the image as the start of the red light state or end of the yellow light state as time T3; and (4) search for the second green state image 607 that next changes from red to green and mark the timestamp associated with the image as the end of the red light state or start of the next green light state as time T4.

The processing module 205 can then calculate the transition times for the different states as follows: (1) green-to-yellow transition time 609 = T2-T1; (2) yellow-to-red transition time 611 = T3-T2; and (3) red-to-green transition time 613 = T4-T3. The overall cycle time 615 (e.g., from green to yellow to red to back to green) can be calculated as T4-T1.

In one embodiment, instead of the performing direct analysis of the image data 129 and/or probe data 127, the processing module 205 can instead retrieve real time vehicle sensor event data with the associated time stamp and geolocation tags if available. In other words, the identification of the traffic light state transitions can be performed on an edge device (e.g., the vehicle 105 and/or UE 113) as sensor events and the resulting sensor event data provided to the mapping platform 117 or another equivalent component. In one embodiment, the edge device can use the various embodiments described herein to determine traffic light states locally at the edge device so that the probe data 127 and/or image data 129 need not be transmitted from the edge device thereby improving privacy/security and reducing the bandwidth, memory, and computing resources needed to transmit and process the raw probe data 127 and/or image data 129 on the backend or server side.

Accordingly, in one embodiment, the processing module 205 requests and receives the sensor event data corresponding to the traffic light transitions of interest for verification of the received SPaT data 111. Examples of the sensor events related to traffic light state transitions include but are not limited to:
The time and geolocation when the green to yellow event happens.
The time and geolocation when the yellow to red event happens.
The time and geolocation when the red to green event happens.

The processing module 205 can then determine the intersection traffic light green, yellow, and red transition times, and cycle time as described above with respect to FIG. 6. An example of calculating transition and cycle times from vehicle sensor event data is as follows:
T1: green to yellow event,
T2: yellow to red event,
T3: red to green event,
T4: green to yellow event
Duration of yellow light = T2-T1
Duration of red light = T3-T2, and
Duration of green light = T4 -T3.

In step 307, the processing module 205 performs a comparison of signal phase and timing (SPaT) data of the traffic light with the transition time, the cycle time, or a combination thereof. In one embodiment, the SPaT data includes a programmed transition time (e.g., for each traffic light state), a programmed cycle time, or a combination thereof for the traffic light. The comparison then comprises comparing the determined transition times (e.g., the observed SPaT data 133) with the programmed transition times (e.g., the received SPaT data 111), comparing the determined cycle time (e.g., the observed SPaT data 133) with the programmed cycle time (e.g., the received SPaT data 111), or a combination thereof.

For example, using deep learning techniques as described in the example of FIG. 6 above, T2-T1 is the green transition time 609, T2-T1 as the green transition time 609 will be compared with green transition time in the received SPaT data 111. If the delta is less than a designated difference threshold, the processing module 205 can verify the SPaT green cycle data is correct.

The process can then be repeated for each transition time (e.g., yellow transition time, red transition time) and/or the overall cycle time of the traffic light 103 that is in the received SPaT data 111 against the observed SPaT data 133 for verification. The output of the verification (e.g., an indication of the delta between observed and received SPaT transition and/or cycle times for each traffic light 103; or a flag indicating whether a received transition time is correct or incorrect) can be provided as SPaT verification data 135. A similar comparison can be made for observed SPaT data 133 generated using probe data 127 and/or sensor event data reported from edge devices.

In one embodiment, the processing module 205 determines a quality level of the SPaT data based on the comparison based on a difference threshold, a magnitude of difference, or a combination thereof. For example, the quality level can be correct or incorrect as described above. Alternatively, the processing module 205 can use different ranges of the difference threshold and/or magnitude of different to correspond to different quality levels. For example, meeting a difference threshold using the tightest criteria (e.g., < 10% difference) can be classified as a “good quality level,” meeting a less stringent but still acceptable difference threshold (e.g., < 20%) can be classified as “acceptable quality level,” and then anything else (e.g., ≥ 20%) can be classified as “not acceptable.” It is noted that this example is provided by way of illustration and not as limitations. It is contemplated that any criteria or rule for specifying a quality level can be used according to the embodiments described herein.

In step 309, the output module 207 provides the comparison of the SPaT data (e.g., SPaT verification data 135) as an output. The output can also include the determined quality level of the SPaT data (as determined in the embodiments above). The output can be provided to the traffic management agency 107 and/or any other component of the system 100 including but not limited to the service platform 119, services 121, and/or content providers 123.

In one embodiment, the mapping platform 117 can use the SPaT verification data 135 to control the operation of the vehicle 105. For example, if an autonomous vehicle 105 is approaching an intersection 101 with a traffic light 103 associated with an incorrect SPaT information classification, the vehicle 105 can take additional measures such as taking a more conservative driving profile (e.g., slowing down), activating additional sensors or sensor modes (e.g., increasing scanning frequency of certain sensors), taking an alternate route, requesting that a passenger/driver take manual control, etc. In another example, the SPaT verification data 135 can be provided as a map data layer of the geographic database 131. In this way, the mapping platform 117 can present maps to indicate which traffic lights may be malfunctioning or have potentially inaccurate SPaT information.

Returning to FIG. 1, as shown, the system 100 includes the mapping platform 117 for SPaT data verification using sensor data (e.g., image data 129) and probe data 127. In one embodiment, the mapping platform 117 has connectivity over the communication network 109 to services platform 119 that provides one or more services 121 that can use the SPaT verification data 135 for downstream functions. By way of example, the services 121 may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 121 uses the output of the mapping platform 117 (e.g., observed SPaT data 133 and/or SPaT verification data 135) to provide services such as navigation, mapping, other location-based services, etc. to the vehicles 105, UEs 113, applications 115, and/or other client devices.

In one embodiment, the mapping platform 117 may be a platform with multiple interconnected components. The mapping platform 117 may include multiple servers, intelligent networking devices, computing devices, components, and corresponding software for determining map feature identification confidence levels for a given user according to the various embodiments described herein. In addition, it is noted that the mapping platform 117 may be a separate entity of the system 100, a part of one or more services 121, a part of the services platform 119, or included within components of the vehicles 105 and/or UEs 113.

In one embodiment, content providers 123 may provide content or data (e.g., including image data 129, probe data 127, related geographic data, etc.) to the geographic database 131, machine learning system 125, the mapping platform 117, the services platform 119, the services 121, the vehicles 105, the UEs 113, and/or the applications 115 executing on the UEs 113. The content provided may be any type of content, such as imagery, probe data, machine learning models, permutations matrices, map embeddings, map content, textual content, audio content, video content, image content, etc. In one embodiment, the content providers 123 may provide content that may aid in SPaT data verification according to the various embodiments described herein. In one embodiment, the content providers 123 may also store content associated with the geographic database 131, mapping platform 117, services platform 119, services 121, and/or any other component of the system 100. In another embodiment, the content providers 123 may manage access to a central repository of data, and offer a consistent, standard interface to data, such as a repository of the geographic database 131.

In one embodiment, the vehicles 105 and/or UEs 113 may execute software applications 115 to use observed SPaT data 133, SPaT verification data 135, or other data derived therefrom according to the embodiments described herein. By way of example, the applications 115 may also be any type of application that is executable on the vehicles 105 and/or UEs 113, such as autonomous driving applications, routing applications, mapping applications, location-based service applications, navigation applications, device control applications, content provisioning services, camera/imaging application, media player applications, social networking applications, calendar applications, and the like. In one embodiment, the applications 115 may act as a client for the mapping platform 117 and perform one or more functions associated with determining map feature identification confidence levels alone or in combination with the mapping platform 117.

By way of example, the vehicles 105 and/or UEs 113 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 105 and/or UEs 113 can support any type of interface to the user (such as “wearable” circuitry, etc.). In one embodiment, the vehicles 105 and/or UEs 113 may be associated with or be a component of a vehicle or any other device.

In one embodiment, the vehicles 105 and/or UEs 113 are configured with various sensors for generating or collecting image data 129, probe data 127, related geographic data, etc. In one embodiment, the sensed data represent sensor data associated with a geographic location or coordinates at which the sensor data was collected, and the polyline or polygonal representations of detected objects of interest derived therefrom to generate the digital map data of the geographic database 131. By way of example, the sensors may include a global positioning sensor for gathering location data (e.g., GPS), IMUs, a network detection sensor for detecting wireless signals or receivers for different short-range communications (e.g., Bluetooth®, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 105 and/or UEs 113 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 105 and/or UEs 113 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 105 and/or UEs 113 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 117, services platform 119, services 121, vehicles 105 and/or UEs 113, and/or content providers 123 communicate with each other and other components of the system 100 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

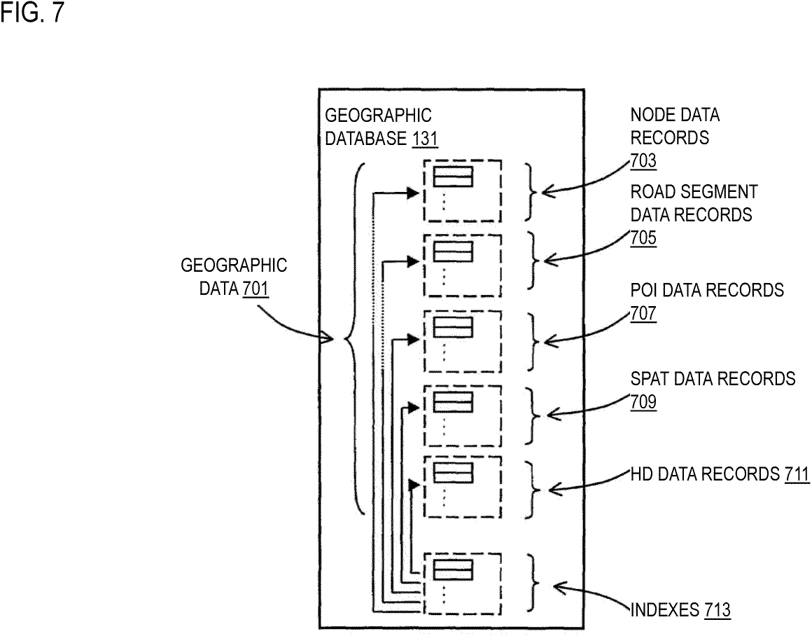

FIG. 7 is a diagram of a geographic database 131, according to one embodiment. In one embodiment, the geographic database 131 includes geographic data 701 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 701. In one embodiment, the geographic database 131 include high definition (HD) mapping data that provide centimeter-level or better accuracy of map features. For example, the geographic database 131 can be based on Light Detection and Ranging (LiDAR) or equivalent technology to collect billions of 3D points and model road surfaces and other map features down to the number lanes and their widths. In one embodiment, the HD mapping data (e.g., HD data records 711) and/or other mapping data of the geographic database 131 capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 131.

“Node” - A point that terminates a link.

“Line segment” - A line connecting two points.

“Link” (or “edge”) - A contiguous, non-branching string of one or more line segments terminating in a node at each end.

“Shape point” - A point along a link between two nodes (e.g., used to alter a shape of the link without defining new nodes).

“Oriented link” - A link that has a starting node (referred to as the “reference node”) and an ending node (referred to as the “non reference node”).

“Simple polygon” - An interior area of an outer boundary formed by a string of oriented links that begins and ends in one node. In one embodiment, a simple polygon does not cross itself.

“Polygon” - An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 131 follows certain conventions. For example, links do not cross themselves and do not cross each other except at a node. Also, there are no duplicated shape points, nodes, or links. Two links that connect each other have a common node. In the geographic database 131, overlapping geographic features are represented by overlapping polygons. When polygons overlap, the boundary of one polygon crosses the boundary of the other polygon. In the geographic database 131, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 131 includes node data records 703, road segment or link data records 705, POI data records 707, SPaT data records 709, HD mapping data records 711, and indexes 713, for example. More, fewer, or different data records can be provided. In one embodiment, additional data records (not shown) can include cartographic (“carto”) data records, routing data, and maneuver data. In one embodiment, the indexes 713 may improve the speed of data retrieval operations in the geographic database 131. In one embodiment, the indexes 713 may be used to quickly locate data without having to search every row in the geographic database 131 every time it is accessed. For example, in one embodiment, the indexes 713 can be a spatial index of the polygon points associated with stored feature polygons. In one or more embodiments, data of a data record may be attributes of another data record.

In exemplary embodiments, the road segment data records 705 are links or segments representing roads, streets, or paths, as can be used in the calculated route or recorded route information for determination of speed profile data. The node data records 703 are end points (for example, representing intersections or an end of a road) corresponding to the respective links or segments of the road segment data records 705. The road link data records 705 and the node data records 703 represent a road network, such as used by vehicles, cars, and/or other entities. Alternatively, the geographic database 131 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 131 can include data about the POIs and their respective locations in the POI data records 707. The geographic database 131 can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 131 can also include SPaT data records 709 for storing received SPaT data 111, observed SPaT data 133, SPaT verification data 135, and/or any other related data that is used or generated according to the embodiments described herein. By way of example, the SPaT data records 709 can be associated with one or more of the node records 703, road segment records 705, and/or POI data records 707 to associate the speed profile data records 709 with specific places, POIs, geographic areas, and/or other map features. In this way, the linearized data records 709 can also be associated with the characteristics or metadata of the corresponding records 703, 705, and/or 707.

In one embodiment, as discussed above, the HD mapping data records 711 model road surfaces and other map features to centimeter-level or better accuracy. The HD mapping data records 711 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 711 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 711.

In one embodiment, the HD mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 131 can be maintained by the content provider 123 in association with the mapping platform 117 (e.g., a map developer or service provider). The map developer can collect geographic data to generate and enhance the geographic database 131. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 131 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicles 105 and/or UEs 113. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing SPaT verification using sensor data (e.g., image data 129) and probe data 127 may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

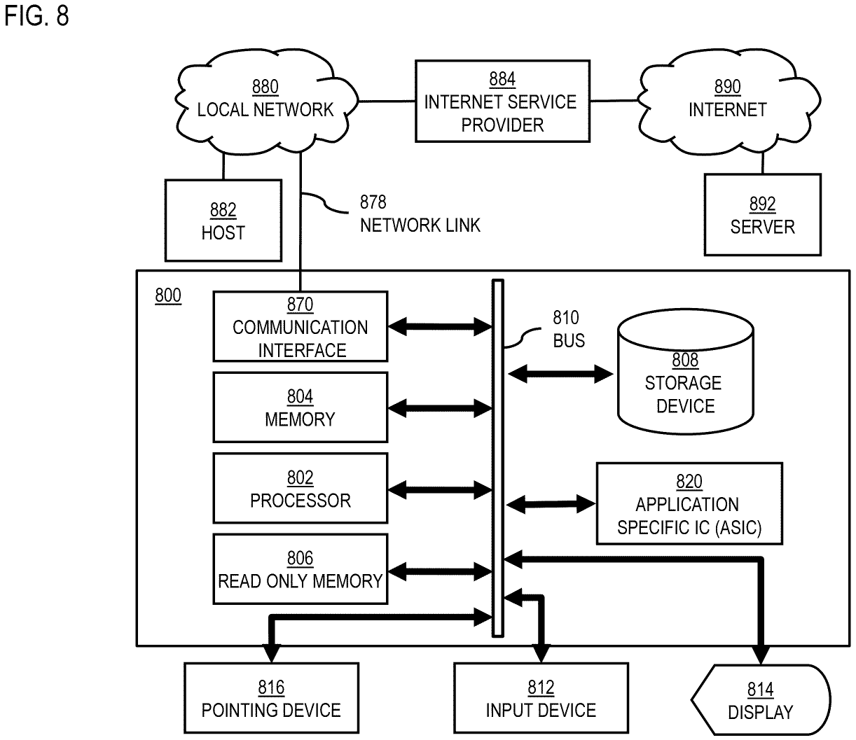

FIG. 8 illustrates a computer system 800 upon which an embodiment of the invention may be implemented. Computer system 800 is programmed (e.g., via computer program code or instructions) to provide SPaT verification using sensor data (e.g., image data 129) and probe data 127 as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing SPaT verification using sensor data (e.g., image data 129) and probe data 127. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing SPaT verification using sensor data (e.g., image data 129) and probe data 127. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing SPaT verification using sensor data (e.g., image data 129) and probe data 127, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 109 for providing SPaT verification using sensor data (e.g., image data 129) and probe data 127.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to provide SPaT verification using sensor data (e.g., image data 129) and probe data 127 as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide SPaT verification using sensor data (e.g., image data 129) and probe data 127. The memory 905 also stores the data associated with or generated by the execution of the inventive steps.

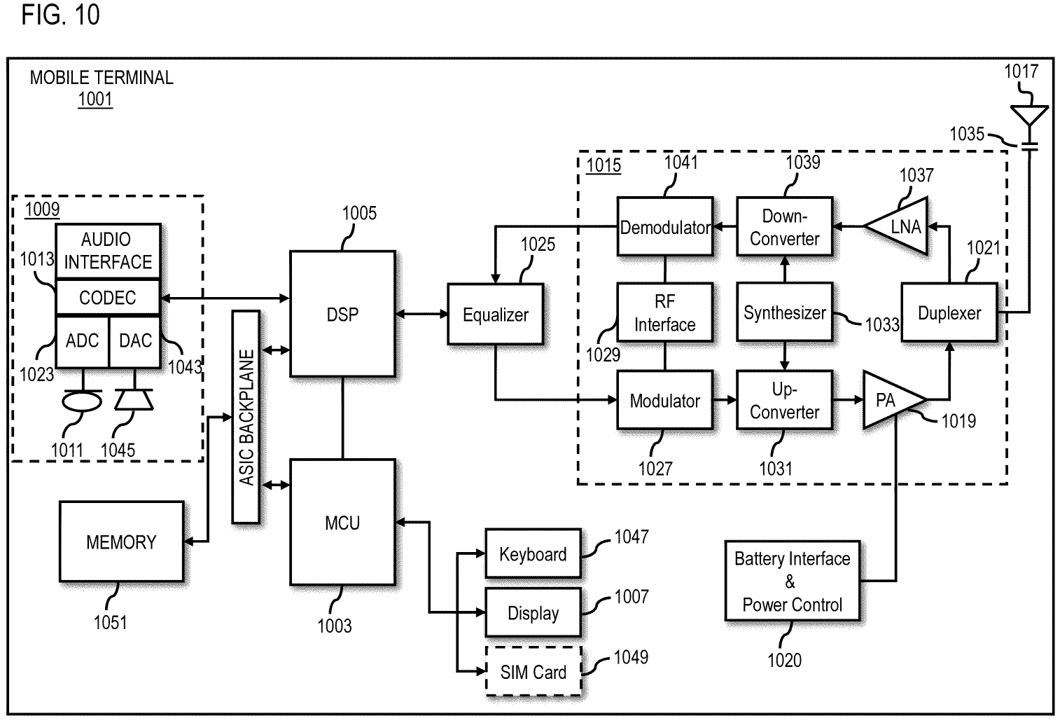

FIG. 10 is a diagram of exemplary components of a mobile terminal (e.g., the UE 113, vehicle 105, or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003–which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to provide SPaT verification using sensor data (e.g., image data 129) and probe data 127. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
retrieving real-time image data captured using a sensor of a vehicle, wherein the vehicle is determined to be traveling within proximity of a traffic light based on probe data;
processing the image data to identify at least one transition of the traffic light between one or more traffic light states;
determining a transition time, a cycle time, or a combination thereof between the one or more traffic light states based on the identified at least one transition of the traffic light;
performing a comparison of signal phase and timing (SPaT) data of the traffic light with the transition time, the cycle time, or a combination thereof;
determining a quality level of the SPaT data based on the comparison, wherein the quality level determined is based at least in part on a difference threshold; and
providing the comparison of the SPaT data as an output, wherein the output is determined based at least in part on the quality level.

2. The method of claim 1, further comprising:
processing probe data collected from the vehicle to determine a deceleration state, an acceleration state, or a combination thereof to determine or verify the at least one transition of the traffic light between the one or more traffic light states.

3. The method of claim 1, wherein the one or more traffic light states include a green-light state, a yellow-light state, a red-light state, or a combination thereof; and wherein the at least one transition is a green-to-yellow event, a yellow-to-red event, a red-to-green event, or a combination thereof.

4. The method of claim 1, wherein the processing of the image data comprises determining the transition time, a transition geolocation, or a combination thereof respectively for the green-to-yellow event, the yellow-to-red event, and the red-to-green event; and wherein the cycle time is determined based on the respective transition times, the respective transition geolocations, or a combination thereof.

5. (canceled)

6. The method of claim 1, wherein the SPaT data includes a programmed transition time, a programmed cycle time, or a combination thereof for the traffic light; and wherein the comparison comprises comparing the determined transition time with the programmed transition time, comparing the determined cycle time with the programmed cycle time, or a combination thereof.

7. The method of claim 1, further comprising:
retrieving probe data collected concurrently with the image data using one or more location sensors of the vehicle;
processing the probe data to determine one or more vehicle speed changes through an intersection associated with the traffic signal; and
determining at least one probe-based transition based on the one or more vehicle speed changes,
wherein the comparison of the SPaT data is further based on the at least one probe-based transition.

8. The method of claim 1, wherein the image data is a sequence of images respectively associated with a capture time, a capture geolocation, or a combination thereof.

9. The method of claim 1, wherein the image data is processed using machine learning to identify the at least one transition.

10. (canceled)

11. An apparatus comprising:
at least one processor; and
at least one memory including computer program code for one or more programs,
the at least one memory and the computer program code configured to, with the at least one processor, cause the apparatus to perform at least the following,
retrieving real-time image data captured using a sensor of a vehicle, wherein the vehicle is determined to be traveling within proximity of a traffic light based on probe data;
processing the image data to identify at least one transition of the traffic light between one or more traffic light states;
determining a transition time, a cycle time, or a combination thereof between the one or more traffic light states based on the identified at least one transition of the traffic light;
determining a quality level of the SPaT data based on the comparison, wherein the quality level determined is based at least in part on a difference threshold; and
providing the comparison of the SPaT data as an output, wherein the output is determined based at least in part on the quality level .

12. The apparatus of claim 11, wherein the apparatus is further caused to:
process probe data collected from the vehicle to determine a deceleration state, an acceleration state, or a combination thereof to determine or verify the at least one transition of the traffic light between the one or more traffic light states.

13. The apparatus of claim 11, wherein the one or more traffic light states include a green-light state, a yellow-light state, a red-light state, or a combination thereof; and wherein the at least one transition is a green-to-yellow event, a yellow-to-red event, a red-to-green event, or a combination thereof.

14. The apparatus of claim 11, wherein the processing of the image data comprises determining the transition time, a transition geolocation, or a combination thereof respectively for the green-to-yellow event, the yellow-to-red event, and the red-to-green event; and wherein the cycle time is determined based on the respective transition times, the respective transition geolocations, or a combination thereof.

15. (canceled)

16. (canceled)

17. (canceled)

18. (canceled)

19. (canceled)

20. (canceled)
